(19) United States
(12) Patent Application Publication
(10) Pub. No.: US 2003/0131146 A1
(43) Pub. Date: Jul. 10, 2003

(54) Interactive monitoring and control of computer script commands in a network environment

(75) Inventors: Thanh V. Lam, Hurley, NY (US); Giampaolo Lauria, Fishkill, NY (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY

(21) Appl. No.: 10/042,581

(22) Filed: Jan. 9, 2002

(51) Int. Cl. G06F 9/00; G06F 9/46

(52) U.S. Cl. 709/320

(57) ABSTRACT

A GUI based system and method for monitoring and controlling command scripts that execute on one or more nodes of a computer cluster or network. The operator is presented with a GUI display that shows commands within a computer command script, a list of nodes upon which the commands will execute, and separate display windows for standard output and errors. Each command within a command script is able to have an associated undo command that reverses the command's operation. The operator may step or cause a subset of commands within the script to be executed.

### BACKGROUND OF THE INVENTION

1. Field of the Invention

This invention generally relates to the field of computer system administration tools, and more particularly relates to a method and system for controlling and monitoring computer command execution on one or more processors within a computer network or cluster.

2. Description of Related Art

Computer operations often require the execution of a series of commands that configure or control the computer's operation. Commands to initialize peripherals, mount file systems or establish communications connections with other devices or computers are often required to place a computer into a proper operating condition. Such configuration of a computer system may be performed by manually entering these individual commands. Manual entry of these commands each time a computer must be configured is undesirable because there are often long sequences of commands, some of which require a series of arguments, options and/or parameters that are often not intuitive and are difficult to remember. As an alternative to manual entry of a series of computer commands, the series of commands may be entered into a computer file, referred to herein as a script file, and that file may then be submitted to the operating system for execution of the commands. Placing computer commands in files fixes the sequence of commands that are executed, and changes in the sequence of commands to perform different overall tasks requires the creation of a new file. The combination of creating, tracking and maintaining a large permutation of files to perform the various tasks required for proper computer operation is a large burden upon the computer system administrators.

Computer networks range from computer clusters comprising several computer processors to a large network of several hundred computers. The administration of computer networks requires the uniform configuration and sometimes reconfiguration of all of the computers on the network. The computers or processors in a cluster or network are generically referred to herein as nodes. Manual execution of script file on all of these nodes is a time consuming task. The script file must be executed on all of the nodes in the network, a task that requires either the operator to manually track which nodes have been initialized, or the network may use a “super-script” that causes execution of the basic script on all of the nodes. Automating the execution of a script on all of the nodes of a network requires a specification of the nodes to be maintained, and alteration of the network, including a temporary unavailability of some of the nodes on a network, requires creation of a new specification of computer nodes. A common technique for causing the same script to be executed on multiple computers is the use of a distributed shell facility.

A distributed shell allows an operating system command or script to be executed on multiple processors, but often fails to notify the operator if there is a difficulty with one of the processors to which the command or script has been dispatched.

The isolation, Identification and correction of problems encountered during the execution of a computer script are difficult processes. This is true for proven scripts and is particularly a problem in the development and debugging of script files. Execution of a computer script is not an interactive process and a problem encountered during execution is not readily isolated to a single command within the script. A problem may be encountered during execution due to a logic flaw or command format within the script itself. Another source of script execution problems is the malfunctioning of the computer upon which the script is executing or problems with other hardware associated with that computer. Node Malfunctions or unavailability are particularly common problems that are encountered when executing a script on multiple computer network nodes. Script execution in a distributed shell environment often causes a large amount of text output from all of the nodes to be displayed on the operator screen. Error messages are included in this stream and may not be noticed by the operator. The operator may mistakenly assume that all nodes have been properly configured when some have not due to errors that were not noticed by the operator. The unavailability of a node or improper execution on a node of a command within a script being executed in a distributed shell environment on multiple nodes can cause the entire execution to “hang.” Isolation of the cause of this malfunction is time consuming since each node must be tested to confirm proper operation. The impact of this is worse during script development where the cause of the problem is assumed to be a logic flaw in the script and not a hardware problem among the executing nodes.

Command scripts that contain configuration commands are particularly difficult to debug or rerun in order to identify the source of errors. Configuration commands within a command script may create problems if they are re-executed within undoing the action of a previous execution of the command. An example of such a configuration command is a command to mount a file system. If a command to mount a file system is executed twice, the same file system will have two mount points. Such multiple executions of configuration commands may induce problems beyond those which caused the initial script failure. Proper isolation of problems encountered during the execution of a script file requires that the effects of commands that were properly executed be undone prior to re-execution of the script in order to attempt to isolate problems. Such undoing of these effects is difficult since the commands that were executed during a failed script execution may not be known. This requires manual identification of the status of the computer node to determine if the status has been altered by commands within the script or a rebooting of the computer as a safety measure.

Therefore a need exists to overcome the problems with the prior art as discussed above, and particularly for a way to monitor and control the execution of computer command scripts that are to execute on one or more computer nodes.

### SUMMARY OF THE INVENTION

According to one aspect of a preferred embodiment of the present invention, a method for interactive monitoring and control of computer script commands in a network environment includes accepting an operator defined plurality of computer commands that are contained within a command file. The plurality of computer commands are then displayed to the operator in a GUI display that allows the operator to accept accepting a selection of at least one of the commands contained within the plurality of computer commands. The selected commands are then executed.

According to another aspect of a preferred embodiment of the present invention, an system for interactive monitoring and control of computer script commands in a network environment includes a command list that contains commands to be executed, a command display that is communicatively coupled to the command list and that displays at least one command within the command list. The system further contains a command selector that is communicatively coupled to the command display and that allows selection of a selected command list, wherein the selected command list contains at least one of the commands that are contained within the command list. The system also contains a command dispatcher that is communicatively coupled to the command selector, that causes the selected command list to execute.

### BRIEF DESCRIPTION OF THE DRAWINGS

FIG. 1 is a block diagram illustrating an interactive computer command script monitoring and control system in accordance with a preferred embodiment of the present invention.

FIG. 2 is a user interface display showing a user interface screen of an interactive computer command script monitoring and control system, according to a preferred embodiment of the present invention.

FIGS. 3 and 4 are diagrams that constitute an operational flow sequence illustrating the processing flow for the GUI Interface of the system of FIG. 1, according to preferred embodiments of the present invention.

### DESCRIPTION OF THE PREFERRED EMBODIMENTS

The present invention, according to a preferred embodiment, overcomes problems with the prior art by providing a graphical user interface (GUI) to present an operator with a display of commands within a script and means for controlling and monitoring execution of those commands. The GUI further aids the operator to select one or more commands within a command script file for execution, allows the operator to control execution of a selected subset of commands contained within the script and to monitor the standard commands outputs and error outputs from the commands in separate window panes within the GUI. The command scripts of the preferred embodiment allow the developer of the script to specify an undo command for some or all of the commands within the script, thereby allowing more efficient “trial and error” debugging and problem identification and isolation. The preferred embodiment further allows the operator to specify one or more computer nodes within a network or cluster upon which the commands contained within the script will be simultaneously executed. In a preferred embodiment, an error in execution of the command script in a multiple processor environment will result execution of commands on each individual processor to aid in the identification of processors which are not properly responding.

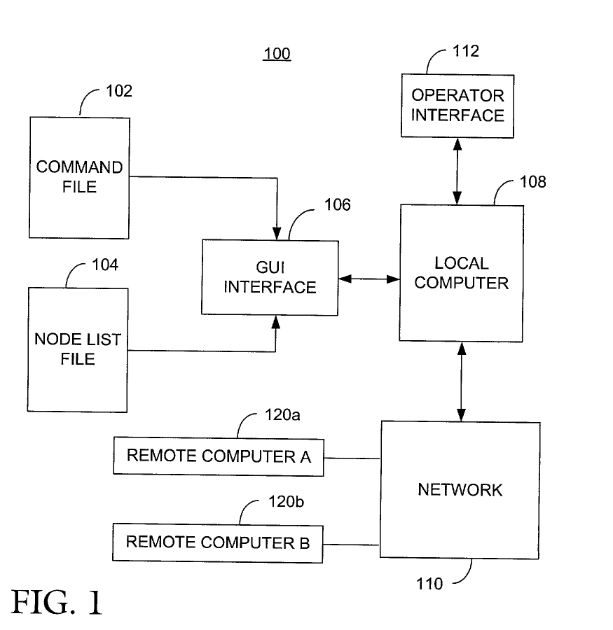

A schematic of one exemplary system architecture 100 for a preferred embodiment of the present invention is illustrated in FIG. 1. The exemplary system architecture 100 comprises a GUI interface 106 to allow the operator to monitor and control execution of computer commands. The GUI interface 106 of this exemplary embodiment executes upon a local computer 108. The GUI interface 106 accepts inputs from a command file 102 and a node list file 104. The command file 102 contains a list of computer operating system commands that are to be executed in conjunction with the operation of this exemplary embodiment of the present invention. The operating system commands in the command file 102 are able to include application programs that execute under an operating system and are also able to include operating system commands for direct execution. The node list file 104 contains a list of computer nodes on which to execute the commands contained within the command file 102. The node list file 104 contents can include a single processor node, such as the local computer 106. The node list file 104 is also able to include one or more other computer nodes that are communicatively coupled to the local computer 108. The local computer 108 of the exemplary embodiment is connected to a computer network 110 which provides communications between the local computer 108 and one or more remote computers, such as remote computer A 120a and remote computer B 120b, on which computer operating system commands that are monitored and controlled through the GUI interface 106 are able to execute. The local computer 108 also has an operator interface 112 that, in preferred embodiments, comprises a display, a keyboard and a mouse or other pointer control device. The operator interface is able to utilize other operator input and/or output devices as are known to practitioners in the relevant arts.

The commands contained within the command file 102 of the exemplary embodiment have associated undo commands. An undo command that is associated with a command within the command file 102 is determined by the designer of the command file and is particular to the command to which it is associated. The contents of an exemplary command file 102 are shown below:

# Exemplary Command File
/u/java/create_FS; exportfs -a # Select one node before do this cmd
mount node1:/server_dir/mntpt #U unmount/mntpt
mount node2:/server_dir/mntpt #U unmount/mntpt
cp/etc/LoadL.cfg/etc/LoadL.cfg.orig
cp/mntpt/LoadL.cfg/etc/LoadL.cfg #U cp/etc/LoadL.cfg.orig/etc/LoadL.cfg
mkdir/home/loadl #U rm/home/loadl
/mntpt/perl/scripts/install2.pl #U/mntpt/perl/scripts/uninstall2.pl

In the above command file example, the ‘#’ character follow by a space indicates that the rest of the line is a comment. The ‘#’ character followed by the uppercase ‘U’, i.e., the string “#U”, indicates that the following text is the “undo” command for the preceding command on that line.

An example of a command/undo command as is illustrated in the above exemplary file is a command to mount a file system. The undo command in this case is an unmount command which unmounts the file system mounted in the associated command. The command and undo command in this pair of commands utilize the same or similar arguments and parameters to ensure the action of the command is reversed by the associated undo command.

In the exemplary command file contents listed above, the first line is a comment identifying the file. This command script is simultaneously executed upon multiple nodes, as specified by the node list file 104, under the control of the GUI interface 106. The first command of the first command line, /u/java/create_FS, is itself a command script file. The exemplary embodiment of the present invention executes that script file without operator interaction. Alternative embodiments provide the operator with an option to interact with the execution of scripts listed in the command file 102. The first command line contains a second command. The exemplary embodiment allows multiple commands to be listed on a single line, with the separate commands separated by a ‘;’ character. The second command of the first command line, exportfs -a, executes after the /u/java/create_FS command. The first command line in this exemplary command file 102 executes upon all of the nodes upon which the command file is executed and operates to create a file system on each node and to export the created file system.

The second and third command line of this exemplary command file 102 cause the file systems that were created by the first commands upon two of the processor nodes, processor nodel and processor node2, respectively, to be mounted at the /mntpt mount point on each node executing these commands. These two commands contain corresponding unmount commands that cause the nodes mounted by the commands to be unmounted.

The fourth command line of this exemplary command file 102 makes a copy of a first file. This command does not require an undo command since repeated operation of this command does not create adverse effects. The fifth command overwrites this first file. The undo command for this fifth command recreates this first file by copying the file created in the previous command back to the original file.

The sixth command of this exemplary command file 102 creates a directory and provides an undo command to cause removal of the directory.

The seventh command of this exemplary command file 102 executes a script, “install2.pl,” that operates upon all processor nodes. The script of the seventh command has an undo command that is also a script, “uninstall2.pl.” In this exemplary embodiment, the undo command script is created by a script developer to perform the tasks required to undo the operation of the command script “install2.pl.”

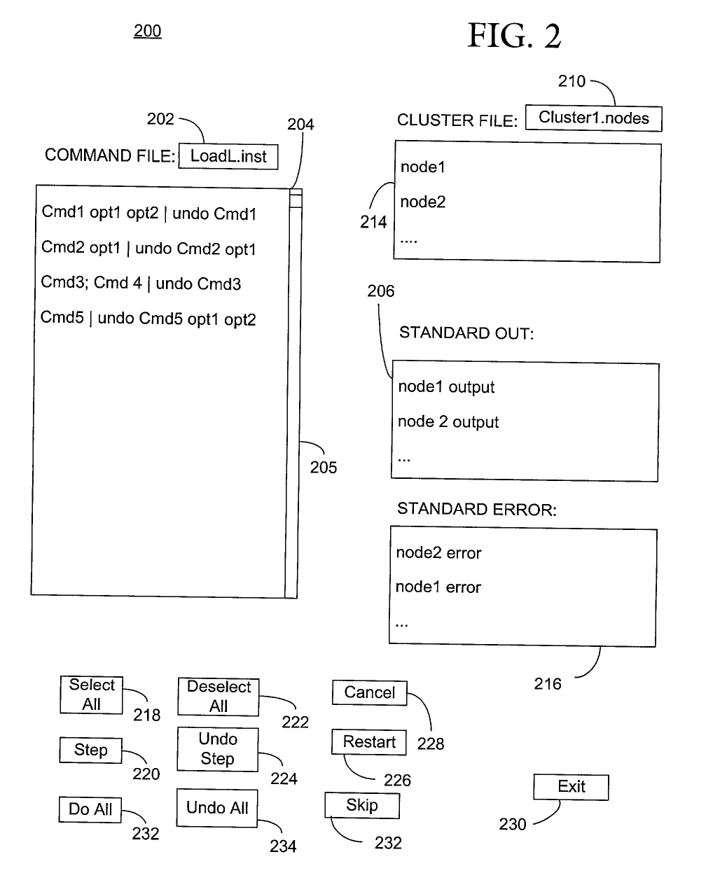

An exemplary GUI display 200 as displayed by an exemplary embodiment of the present invention is illustrated in FIG. 2. The exemplary GUI display 200 contains multiple displays that include windows, or window panes, that display text and allow the operator to scroll through the displayed text to view text above or below that displayed. Data that is referred to herein as displayed “in” a window include, in addition to the data currently displayed in the window, those items which are not currently displayed in the window but which are accessible by scrolling the window by user of the GUI functions that are available as are known to practitioners in the relevant arts. This exemplary GUI display 200 includes a command file field 202 that indicates the name of the command file 102. In the exemplary embodiment, the command file 102 is a computer data file that contains textual representations of operating system commands in ASCII text format. Alternative embodiments may incorporate command files 102 that are encoded or stored through alternative methods, including storage in ROM or communicated through a variety of communications techniques. The exemplary GUI display 200 also contains a command window 204 that displays a portion of the commands contained within the command file 102. The command window 204 of the exemplary embodiment allows the operator to scroll up and down in order to display different parts of the command file 102. The command window 204 contains a scroll bar 205 which allows the operator to scroll the contents of the command window by using a pointing device and the slider of the scroll bar 205. The operator is able to also scroll the contents of the command window by using control characters entered from a keyboard that is part of the operator interface 112. Control characters are associated with special function keys in the exemplary embodiment, such as the “page up” and “page down” keys on the keyboard that is part of the operator interface 112. The command window 102, along with the operator interface 112, of the exemplary embodiment provide a command selector that allows the operator to select one or more commands listed within the command window 102. The operation of the exemplary embodiment allows the selected commands, or selected command list, to be executed either singularly or as a group. Commands are selected in the exemplary embodiment through the use of GUI operations that include placing a pointer, that is controlled by movement of a mouse input device of the GUI interface, over the command to select and clicking a mouse button to select the command which is under the GUI display pointer.

The exemplary GUI display also contains a cluster file indication field 210 and a cluster file display window 214. The cluster file indication field 210 in the exemplary embodiment displays the name of the computer file that contains a list of computer nodes on which the commands of the command file 102 will execute. The exemplary GUI display 200 contains separate displays or windows that separately display the standard output and standard error output from executing programs. The standard output window 206 displays the text output from all nodes that are executing the commands under control of the exemplary GUI interface 106. The standard error window 216 displays the standard error output generated by the programs executing on the one or more nodes under control of the GUI interface 106. Alternative embodiments of the present invention utilize separate physical displays to contain the standard output window 206 and the standard error window 216.

The exemplary GUI display 200 further includes a number of GUI function buttons. GUI function buttons are a GUI facility which allows a GUI interface operation that is associated with the function button to be performed. The functions of the GUI function buttons illustrated in the exemplary GUI display 200 are described below. In the description of the exemplary embodiments, selection of an operation through activation of a function button is referred to as “pressing” the associated function button, as is known to practitioners in the relevant arts.

The command window 204 of the exemplary embodiment allows the operator to select one or more of the commands that are displayed within the command window 204. A command selector of the exemplary embodiment allows commands to be selected through the various techniques implemented in GUI interfaces to select multiple items in a display window, as are known to practitioners in the relevant arts. The Select All function button 218 in the exemplary GUI display 200 allows the operator to select all of the commands that are listed within the command window, including those commands not currently displayed but are accessible by scrolling through the command window 204. Pressing the Select All function button 218 has the effect of selecting each command contained within the command file 102.

The Deselect All function button 222 has the effect of deselecting all of the commands which are selected within the command display window 204. The commands which are selected may have been selected by any means supported by the particular embodiment.

Selecting the Do All function button 232 triggers the command dispatcher of the exemplary embodiment to causes all of the commands which have been selected, i.e., the selected command list, to execute on the computer nodes displayed within the node window 214. The set of commands that are selected are able to be a subset of the commands listed in the command file 102 as well as all of the commands. The commands that are selected are also able to be non-contiguous commands within the command file 102. Non-continuous commands are selected by using the GUI facilities to select non-contiguous commands, and then these commands are executed by pressing the Do All function button 232. Methods to select non-contiguous entries in a GUI window are known to practitioners and include pressing a keyboard key, such as the ‘control’ key, during selection of multiple, non-contiguous entries. Execution of non-contiguous commands in the exemplary embodiment of the present invention affords several advantages in the development, debugging and maintenance of scripts. Execution of non-contiguous commands allows commands to be skipped in order to isolate problems with script execution. Execution of non-contiguous commands also allows flexible use of existing scripts by allowing an operator to easily execute only a portion of a script or to execute most of a script but excluding some commands.

Two function buttons of the exemplary GUI display 200 support the command step functionality of the command dispatcher within the exemplary embodiment of the present invention. The exemplary embodiment allows an operator to select one or more commands within the command file 102. The selected commands may be contiguous or non-contiguous as is described in associated with the Do All function button 232. The command step functionality of the exemplary embodiment allows an operator to execute individual commands within the group of selected commands. The step functionality begins by an operator selecting a group of command within the commands that are displayed within the command window 204. Upon selection of selected commands, which are a set of commands that were selected by the operator from within the command window 204, the first instruction of the selected commands is indicated as the next instruction to be executed. Pressing the Step function button 220 causes execution of the command that is indicated as the next command to execute. After execution of the indicated command, the next command within the selected commands is indicated as the next command to execute and is executed when the Step function button 220 is next selected by the operator. For example, the first operation of the Step function button 220 after a set of commands within the command window 204 is selected causes the first command within the selected commands to execute. After the execution of that first command, the second selected command is then indicated as the next instruction to execute. Execution of the indicated command and indication of the next command within the selected commands continues until the last command within the selected commands is executed. The Step function button 220 allows the results of each command to be observed and/or evaluated prior to execution of the next selected command.

The exemplary embodiment of the present invention allows undo commands to be associated with each command listed in the command file 102 as is described herein. The exemplary GUI display 200 includes two function buttons to allow the operator to select operation of the undo commands that are associated with commands within the command file 102. One GUI interface function button is the Undo Step function button 224 which allows the operator to execute the undo command that is associated with the next instruction that is indicated for execution. The Undo Step function button 224 is also able to be used after just one command within the command window 204 is selected. This allows the operator to undo the effect of selected commands while preserving the status of the one or more computer nodes as they were altered by other commands within a script. The Undo All function button 234 causes execution of undo commands that are associated with the selected commands. The operation of the Undo All function button 234 allows the effect of selecting the Do All function button 232 to be easily undone.

The Cancel function button 228 allows the operator to halt the execution of a single command, after the operator's selection of the Step function button 220, or to stop the execution of a set of selected commands after the operator's selection of the Do All function button 232. The Restart function button 226 allows the operator to restart the execution of a single command or a set of selected commands after the operator selects the Cancel function button 228.

The Exit function button 230 causes the GUI interface 106 program to halt execution. Pressing the Exit function button 230 causes the GUI interface 106 program to cease execution and returns control to the operating system of the local computer 108.

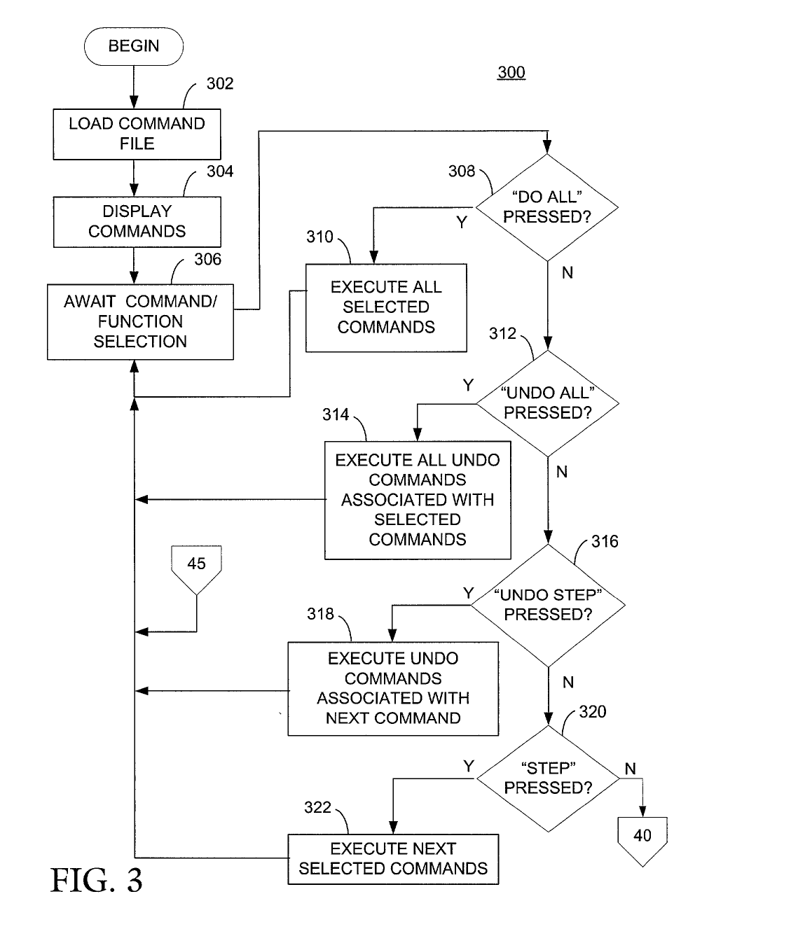

An exemplary GUI processing flow 300 is illustrated in FIG. 3. The processing of the exemplary embodiment begins by loading, at step 302, the contents of the command file 102. The contents are then displayed, at step 304, in the scrolling command window 204. Once the commands are displayed, the exemplary processing then allows the operator to select commands that are displayed in the command window 204. The processing awaits an operator selection, at step 306, and once an operator selection of commands is made, the operator selection is accepted by the processing and the selected commands will be used for further processing. The exemplary embodiment allows the operator to select either the entire list of commands that are within the command window, through use of the Select All function button 218, or the operator may select only a subset of those commands. After the operator selects commands within the command window 204, the processing waits for the operator to press a function button prior to continuation of processing.

Once a command selection has been accepted, the processing of the exemplary embodiment then determines, at step 308, if the operator presses the Do All function button 232. If the operator does press the Do All function button 232, the processing then executes, at step 310, all of the commands that the operator had previously selected. If the operator had pressed the Do All function button 232, the processing returns to await, at step 306, another selection of commands or pressing of a function button.

If the operator had not pressed the Do All function button 232, the processing advances to determine, at step 312, if the operator presses the Undo All function button 234. If the operator had pressed the Undo All function button 234, the processing then continues by executing, at step 314, the undo commands that are associated with the selected commands.

If the operator did not press the Undo All function button 234, the processing then advances to determine, at step 316, if the operated pressed the Undo Step function button 224. If the operator did press the Undo Step function button 224, processing continues, at step 318, by executing the undo command that is associated with the “next” command. The next command is the command that is marked for execution, as is described herein.

If the operator did not press the Undo Step function button 224, the processing then advances to determine, at step 320, whether the operator pressed the Step function button 220. If the operator did press the Step function button 220, the next command in the selected command list is executed, at step 322. If the operator did not press the Step function button 220, nor any other function button that was previously tested in the above processing, the processing of the exemplary embodiment advances to the handle other function buttons processing 400.

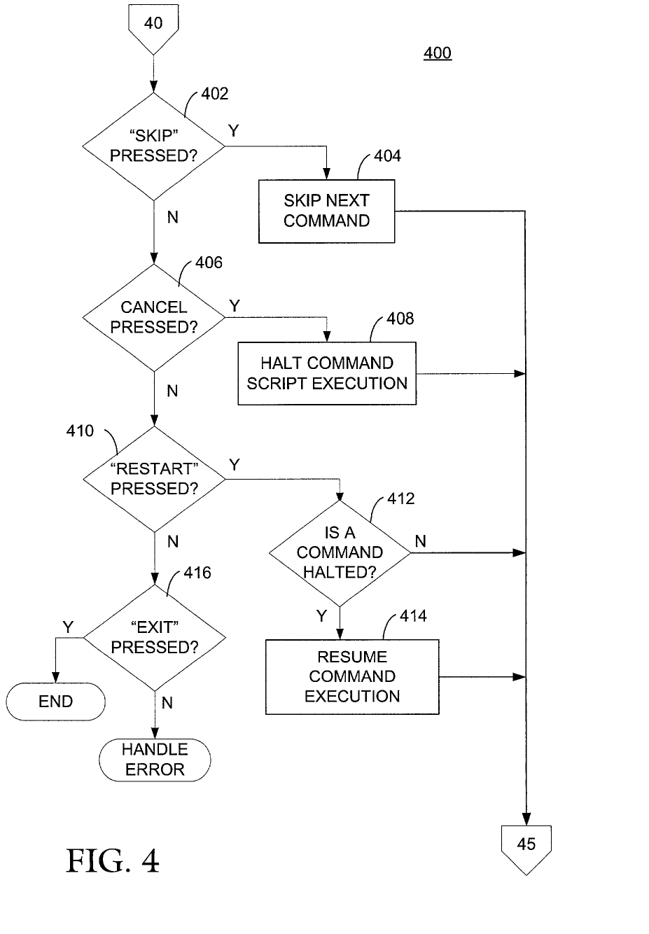

The handle other function buttons processing 400 of the exemplary embodiment is illustrated in FIG. 4. Upon entry into the handle other function buttons processing 400, the processing determines, at step 402, whether the operator has pressed the Skip function button 232. If the operator has pressed the Skipped function button 232, the processing causes the next command within the selected commands to be skipped. This is in contrast to the operation of the Step function button 220, which causes the next command to execute. Subsequent to pressing the Skip function button 232, the selected command following the next command is indicated to be the next command to execute. Processing then returns to the exemplary GUI processing flow 300 to await further operator selections, at step 306.

If the operator did not press the skip function button 232, the processing next determines, at step 406, whether the operator has pressed the cancel function button 228. If the operator has pressed the Cancel function button 228, processing advances to halt the execution, at step 408, of the currently executing command and script. The operation of the Cancel function button 228 causes that command to halt if the Step function button 220 had been previously pressed by the operator. If the operator has pressed the Do All function button 232, pressing the Cancel function button 228 causes the execution of the executing subset of the command file 102, i.e., the selected commands, to halt. The operation of the Cancel function button causes the command or script to be placed in a halted state. The processing then returns to the exemplary GUI processing flow 300 to await further operator selections, at step 306.

If the operator did not press the Cancel function button 228, the processing next determines if the operator pressed the Restart function button 226, at step 410. The Restart function button allows resumption of operation of a command or script if the Cancel function button 228 has been pressed and a command or script is halted. If the operator did press the Restart function button 226, the processing then determines, at step 412, whether a command or script is halted. If a command has not been halted, such as through operation of the processing associated with the Cancel function button 228, selection of the Restart function button 226 when there is not a currently halted command is not a proper selection in the exemplary embodiment and processing returns to the exemplary GUI processing flow 300 to await further operator selections. If there is a halted command, the processing continues by resuming, at step 414, the command or script which was halted. The processing then returns to the exemplary GUI processing flow 300 to await further operator selections, at step 306.

If the operator has not pressed any of the above described function buttons, processing continues by determining, at step 416, if the operator has pressed the Exit function button 230. Pressing of the Exit function button causes the GUI interface 106 to halt operation. If none of the above operator selections is determined to have been made, the operation of the exemplary GUI interface processing flow proceeds by handling the error due to the unrecognized command. Preferably, an error message is displayed on the screen and the skip command button 232 can be default selected to pass control of the processing to the exemplary GUI processing flow 300 to await further operator selections, at step 306.

The exemplary embodiment of the present invention further supports automated isolation of unavailable computer nodes. The exemplary embodiment of the present invention uses the distributed command shell, as is known to practitioners in the relevant arts, to simultaneously execute commands upon multiple computer nodes. The use of the distributed shell does not provide an express indication to the operator that one or more processor nodes are unavailable. When one or more nodes execute a command on multiple processors, the unavailability of one or more of those possessors causes the processing to “hang” and no further response is observed by the operator. The exemplary embodiment of the present invention incorporates an automated technique to identify when a command hangs and then determines which node is unavailable. The processing of the exemplary embodiment determines that a distributed shell command has hung and then initiates sequential, remote execution of that command on each processor node upon which the command was executed through the distributed shell. The processing of the exemplary embodiment submits the command to a first processor node for execution, and then monitors the remote execution of the command for a response. If no response is received, the processor node is indicated as unavailable. If a response is received, processing continues by submitting the same command to a next remote processor node for execution. The command is thus serially submitted for remote execution on each processor node within the node list 104.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method comprising:
accepting an operator defined plurality of computer operating system commands;
displaying the plurality of computer operating system commands;
accepting a selection of at least one computer operating system command from within the plurality of computer operating system commands; and
executing the at least one computer operating system command contained within the selection.

2. The method of claim 1, wherein the operator defined plurality of computer operating system commands is contained within a data file.

3. The method of claim 1, wherein the executing comprises single stepping through each computer operating system command within the selection.

4. The method of claim 1, further including displaying a program output and an error output within separate displays, wherein the separate displays are at least one of separate GUI windows and separate display screens.

5. The method of claim 1, wherein the executing is performed on a plurality of processors.

6. The method of claim 5, wherein the executing comprises:
detecting a failure to execute the at least one computer operating system command on the plurality of processors; and
determining at least one processor within the plurality of processors that is unavailable for executing the at least one computer operating system command.

7. The method of claim 6, wherein the determining comprises individually requesting execution of one of the at least one computer operating system command on each of the plurality of processors.

8. A method comprising:
defining a plurality of computer operating system commands;
associating each of at least one computer operating system command within the plurality of computer operating system commands with one of at least one undo command;
displaying the plurality of computer operating system commands;
displaying the at least one undo command along with an identification of an associated computer operating system command to which each of the at least one undo command is associated;
accepting a selection of a selected undo command; and
executing the selected undo command.

9. A system comprising:
a memory for storing a computer operating system command list;
a command display, communicatively coupled to the memory, for displaying at least one computer operating system command of the computer operating system command list;
a command selector, communicatively coupled to the memory and the command display, for selecting at least one computer operating system command contained within the computer operating system command list; and
a command dispatcher, communicatively coupled to the command selector, for causing execution of the selected at lest one computer operating system command contained within the computer operating system command list.

10. The system of claim 9, wherein the computer operating system command list is stored within a data file in the memory.

11. The system of claim 9, wherein the command dispatcher further performs single stepping through each command within the selected computer operating system command list.

12. The system of claim 9, further comprising a program standard output display and a standard error output display that are each separate displays, wherein the separate displays are at least one of separate GUI windows and separate display screens.

13. A system of claim 9, wherein the computer operating system command list comprises at least one undo command that is each associated with an associated computer operating system command, wherein the command display displays the at least one undo command in association the associated command, and wherein the command dispatcher causes execution of the at least one undo command that is associated with the selected at least one computer operating system command within the computer operating system command list.

14. The system of claim 9, wherein the command dispatcher causes execution of the selected at least one computer operating system command within the computer operating system command list on a plurality of processors.

15. The system of claim 14, wherein the command dispatcher further:
detects a failure to execute the at least one computer operating system command on all of the processors within the plurality of processors; and
determines at least one processor within the plurality of processors that is unavailable.

16. The system of claim 15, wherein the command dispatcher determines at least one processor within the plurality of processors that is unavailable by individually requesting execution of one of the selected computer operating system command list on each of the plurality of processors.

17. A computer readable medium including computer instructions for controlling and monitoring computer command execution, the computer instructions comprising instructions for:
accepting an operator defined plurality of computer operating system commands;
displaying the plurality of computer operating system commands; accepting a selection of at least one computer operating system command from within the plurality of computer operating system commands; and
executing the at least one computer operating system command contained within the selection.

18. The computer readable medium of claim 17, wherein the operator defined plurality of computer operating system commands is contained within a data file.

19. The computer readable medium of claim 17, wherein the instructions for executing comprise single stepping through each computer operating system command within the selection.

20. The computer readable medium of claim 17, further including instructions for displaying a program output and an error output within separate displays, wherein the separate displays are at least one of separate GUI windows and separate display screens.

21. The computer readable medium of claim 17, wherein the instructions for executing cause the executing to be performed on a plurality of processors.

22. The computer readable medium of claim 21, wherein the instructions for
executing comprise instructions for:
detecting a failure to execute the at least one computer operating system command on the plurality of processors; and
determining at least one processor within the plurality of processors that is unavailable for executing the at least one computer operating system command.

23. The computer readable medium of claim 22, wherein the instructions for determining comprise instructions for individually requesting execution of one of the at least one computer operating system command on each of the plurality of processors.

24. A computer readable medium including computer instructions for controlling and monitoring computer operating system command execution, the computer instructions comprising instructions for:
defining a plurality of computer operating system commands;
associating each of at least one computer operating system command within the plurality of computer operating system commands with one of at least one undo command;
displaying the plurality of computer operating system commands;
displaying the at least one undo command along with an identification of an associated computer operating system command to which each of the at least one undo command is associated;
accepting a selection of a selected undo command; and
executing the selected undo command.
